(19) United States
(12) Patent Application Publication
(10) Pub. No.: US 2013/0050557 A1
(43) Pub. Date: Feb. 28, 2013

(54) ROTARY TYPE ELECTRONIC DEVICE

(71) Applicant: Takashi Moriyasu, Daito-shi (JP)

(72) Inventor: Takashi Moriyasu, Daito-shi (JP)

(73) Assignee: SANYO ELECTRIC CO., LTD., Osaka (JP)

(21) Appl. No.: 13/597,648

(22) Filed: Aug. 29, 2012

(30) Foreign Application Priority Data
Aug. 31, 2011 (JP) 2011-188081

(51) Int. Cl. H04N 5/225

(52) U.S. Cl. 348/333.06; 348/E05.026

(57) ABSTRACT

In a rotary type electronic device of the present invention, a second body stores a magnet having the N pole and the S pole. A first body stores an N pole magnetic field sensor and an S pole magnetic field sensor. The magnet is arranged to be in an attitude such that the magnetizing direction axis tilts relative to the second hinge shaft. The S pole magnetic field sensor is arranged at a position on an extended line from the magnetizing direction axis of the magnet where it receives the magnetic field from the S pole, in one of a plurality of states. The N pole magnetic field sensor is arranged at a position on the extended line from the magnetizing direction axis of the magnet where it receives the magnetic field from the N pole, in another one of the states.

### CROSS-REFERENCE TO RELATED APPLICATION

The present application claims priority to Japanese Patent Application No. 2011-188081, the entirety of which is incorporated herein by reference.

### BACKGROUND OF THE INVENTION

1. Field of the Invention

The present invention relates to a rotary type electronic device in which a first body and a second body each being a device component are rotatably coupled to each other via a double shaft hinge mechanism.

2. Description of Related Art

Conventionally, in connection with video cameras, a first housing provided with a taking lens and a second housing provided with a display are coupled to each other via a double shaft hinge mechanism so as to be opened and closed. The double shaft hinge mechanism includes a first hinge shaft coupled to the first housing and a second hinge shaft coupled to the second housing. By rotating the second housing relative to the first housing about the first hinge shaft and/or the second hinge shaft, four states being different from one another in the relative attitude of the second housing to the first housing, that is, the first closed state for carrying, the first open state for shooting the front landscape, the second open state for shooting the user himself/herself, and the second closed state for watching a shot image or shooting an image, can be set.

In the first closed state, the second housing is closed with its display opposed to the side face of the first housing. In the first open state, the second housing is opened from the first housing, and the display of the second housing is oriented toward the user. In the second closed state, the second housing is closed with back face of the second housing opposed to the side face of the first housing. Further, in the second open state, the second housing is opened from the first housing, and the display of the second housing is oriented in the same direction as the taking lens.

Here, in the first closed state, the display is turned OFF; whereas in the first open state, the second closed state and the second open state, the display is turned ON. In contrast to the first open state, the displaying orientation of the display must be inverted upside down in the second open state.

Accordingly, conventionally, in order to address the ON/OFF control of the display and the switching of the display orientation when the display is turned ON, the double shaft hinge mechanism is provided with a first ON/OFF switch that operates in accordance with the rotation about the first hinge shaft and a second ON/OFF switch that operates in accordance with the rotation about the second hinge shaft. Thus, by the combination of the ON/OFF state of the two ON/OFF switches, a plurality of attitudes of the second housing relative to the first housing are determined.

In another manner, first and second magnets are arranged in the second housing. A first magnetic field sensor that senses the magnetic field from the first magnet and a second magnetic field sensor sensing the magnetic field from the second magnet are arranged in the first housing. Thus, by the combination of ON/OFF of the first magnetic field sensor and ON/OFF of the second magnetic field sensor, a plurality of attitudes of the second housing relative to the first housing are determined.

However, in the former manner in which the ON/OFF switches are used, it is difficult to provide the double shaft hinge mechanism with the waterproof performance, and the ON/OFF switches may erroneously operate due to intrusion of water.

In contrast, in the latter manner in which the two magnets and the magnetic field sensors are used, waterproofness is easily achieved because the magnets and the magnetic field sensors can be stored in the housings, respectively. However, there is a problem that it is difficult to achieve a reduction in weight and size because of the necessity of provision of the two magnets. Further, the magnetic fields of the two magnets may interfere with each other, which may invite failure in sensing.

Accordingly, an object of the present invention is to provide a rotary type electronic device that can determine a plurality of attitudes of the second body relative to the first body using one magnet and two magnetic field sensors.

### SUMMARY OF THE INVENTION

A rotary type electronic device of the present invention includes a first body and a second body that are rotatably coupled to each other via a double shaft hinge mechanism 3 having at least two hinge shafts. The double shaft hinge mechanism 3 has a first hinge shaft 7 coupled to the first body and a second hinge shaft 8 coupled to the second body. Rotation of the second body relative to the first body about at least one of the first hinge shaft 7 and the second hinge shaft 8 allows a plurality of states to be set, a plurality of the states that are relative attitudes of the second body to the first body being different from one another.

It is to be noted that, the structure in which the first body and the second body are rotatably coupled to each other includes the mode in which the first body and the second body are coupled so as to be capable of being opened and closed.

Here, the second body stores a magnet 4 being magnetized in one axial direction to have an N pole 41 and an S pole 42. The first body stores an N pole magnetic field sensor 5 sensing a magnetic field generated from the N pole 41 of the magnet 4, and an S pole magnetic field sensor 6 sensing a magnetic field generated from the S pole 42 of the magnet 4.

The magnet 4 is arranged to be in an attitude such that the magnetizing direction axis tilts relative to the second hinge shaft 8. The S pole magnetic field sensor 6 is arranged at a position on an extended line from the magnetizing direction of the axis of the magnet 4 where the S pole magnetic field sensor 6 receives the magnetic field from the S pole 42 in one of a plurality of states. The N pole magnetic field sensor 5 is arranged at a position on the extended line from the magnetizing direction axis of the magnet 4 where the N pole magnetic field sensor 5 receives the magnetic field from the N pole 41, in one of the states other than the one state.

### BRIEF DESCRIPTION OF THE DRAWINGS

FIG. 1 is a perspective view showing a vertical type video camera according to a first embodiment of the present invention in the first open state as seen from the rear side;

FIG. 2 is a perspective view showing the video camera in the intermediate state, i.e., the process of transition from the first closed state to the first open state or the second open state;

FIG. 3 is a perspective view showing the video camera in the first open state as seen from the front side;

FIG. 4 is a three-view drawing showing the video camera in the first closed state;

FIG. 5 is a three-view drawing showing the video camera in the first open state;

FIG. 6 is a three-view drawing showing the video camera in the second closed state;

FIG. 7 is a three-view drawing showing the video camera in the second open state;

FIG. 8 is a perspective view of a horizontal type video camera according to a second embodiment of the present invention in the first open state as seen from the front side;

FIG. 9 is a perspective view showing the video camera in the first open state as seen from the rear side;

FIG. 10 is a three-view drawing showing the first closed state of the video camera;

FIG. 11 is a three-view drawing showing the video camera in the first open state;

FIG. 12 is a three-view drawing showing the video camera in the second closed state;

FIG. 13 is a three-view drawing showing the video camera in the second open state;

FIG. 14 is a table describing control of image display in accordance with the change in the state of the video camera according to the first embodiment; and

FIG. 15 is a graph describing control of an image display in accordance with the change in the state of the video camera according to the second embodiment.

### DETAILED DESCRIPTION OF THE PREFERRED EMBODIMENT

In the following, two embodiments in which the present invention is applied to an open-close type video camera will be specifically described below with reference to drawing.

### 1. First Embodiment

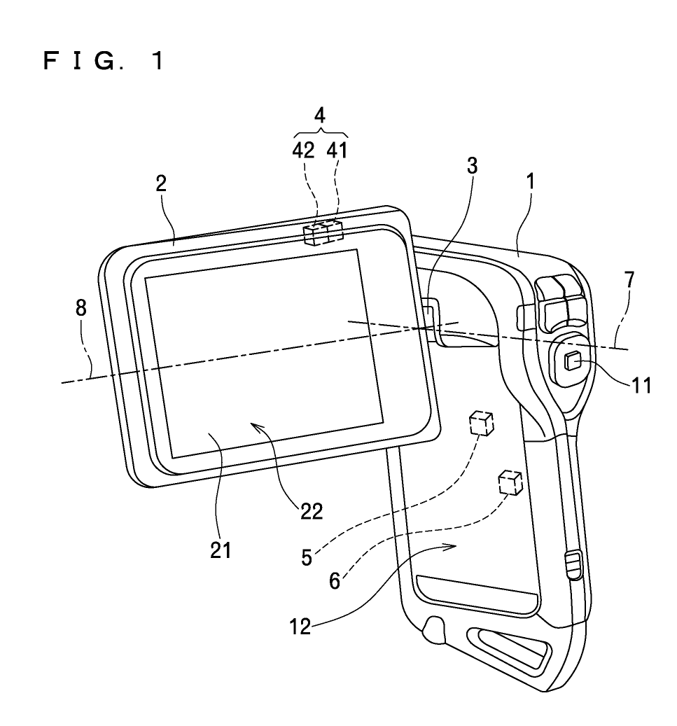

As shown in FIGS. 1, 2 and 3, a video camera according to a first embodiment is a vertical type video camera, and a second housing 2 is coupled to the side portion of a vertically long first housing 1 so as to be opened and closed via a double shaft hinge mechanism 3.

The double shaft hinge mechanism 3 has a first hinge shaft 7 that extends in the front-rear direction and that is coupled to the first housing 1, and a second hinge shaft 8 that extends in the direction being perpendicular to the first hinge shaft 7 and that is coupled to the second housing 2. The first hinge shaft 7 and the second hinge shaft 8 are perpendicular to each other.

The first housing 1 has a side face 12 that is parallel to the first hinge shaft 7, and the second housing 2 has an inner face 22 and an outer face 23 that extend along the second hinge shaft 8.

The first housing 1 is provided with a taking lens 10 and an operation button 11. At the inner face 22 of the second housing 2, a display 21 is arranged.

In the second housing 2, a magnet 4 that is magnetized in one axial direction to have an N pole 41 and an S pole 42 is arranged, such that its magnetizing direction axis is tilted relative to the second hinge shaft 8.

On the other hand, in the first housing 1, an N pole magnetic field sensor 5 capable of sensing the magnetic field generated from the N pole 41 of the magnet 4, and an S pole magnetic field sensor 6 capable of sensing the magnetic field generated from the S pole 42 of the magnet 4 are arranged with a deviation of two directions i.e., in the first hinge shaft 7 direction along the side face 12, and the axial direction being perpendicular to the first hinge shaft 7.

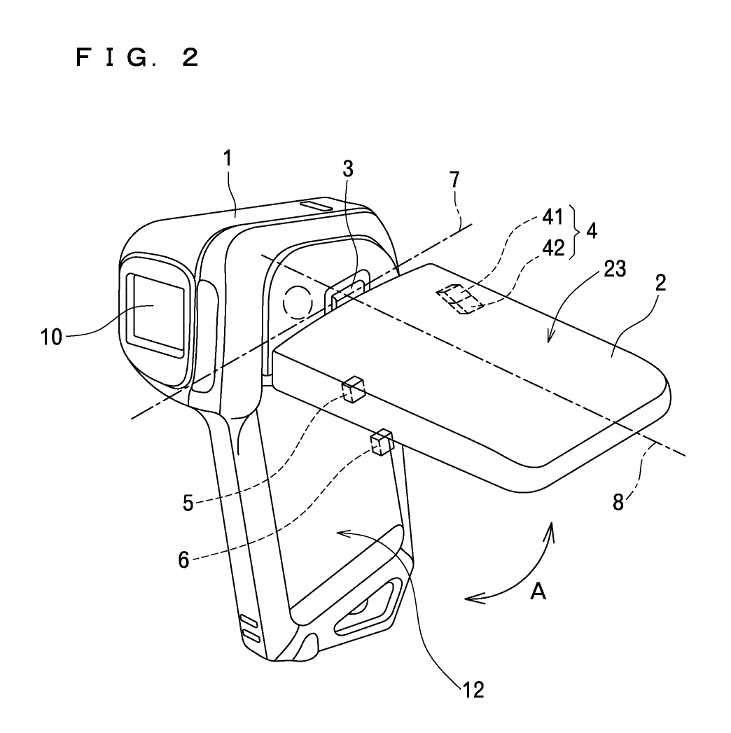

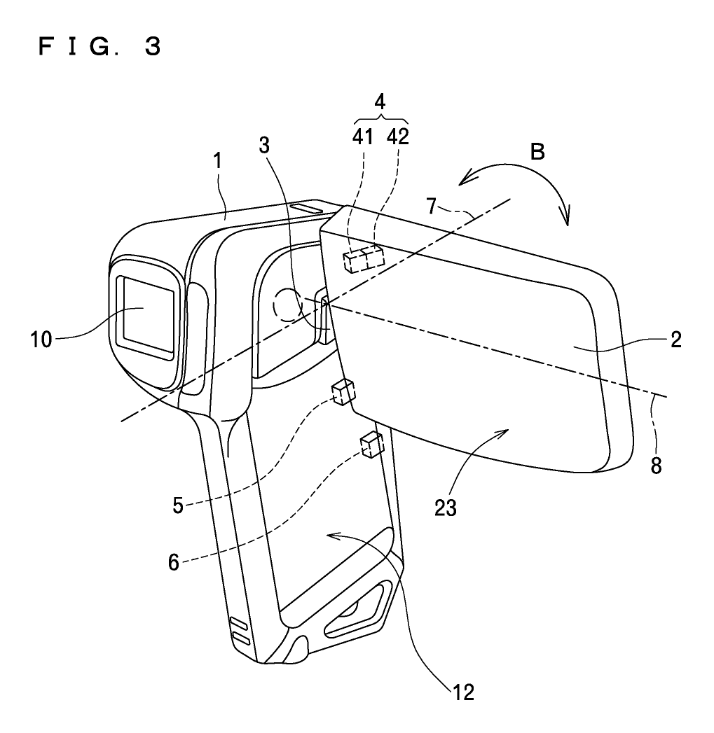

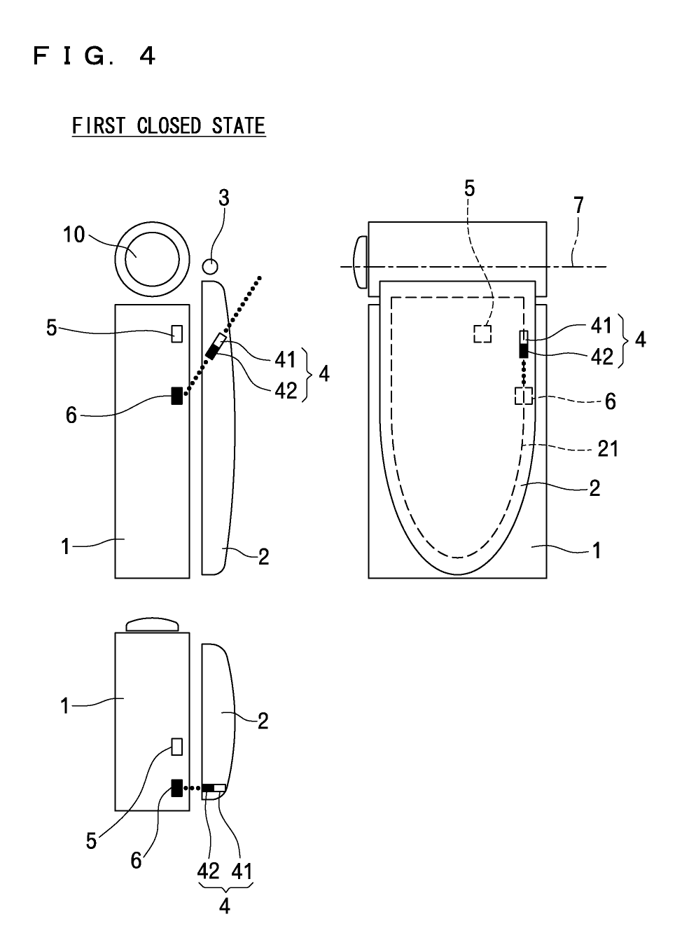

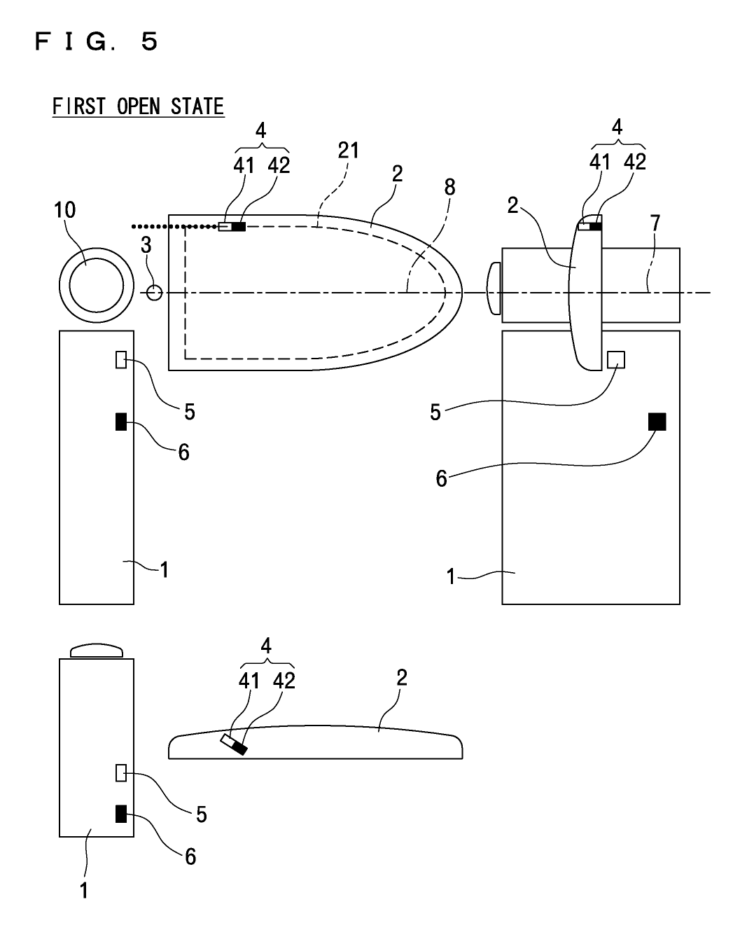

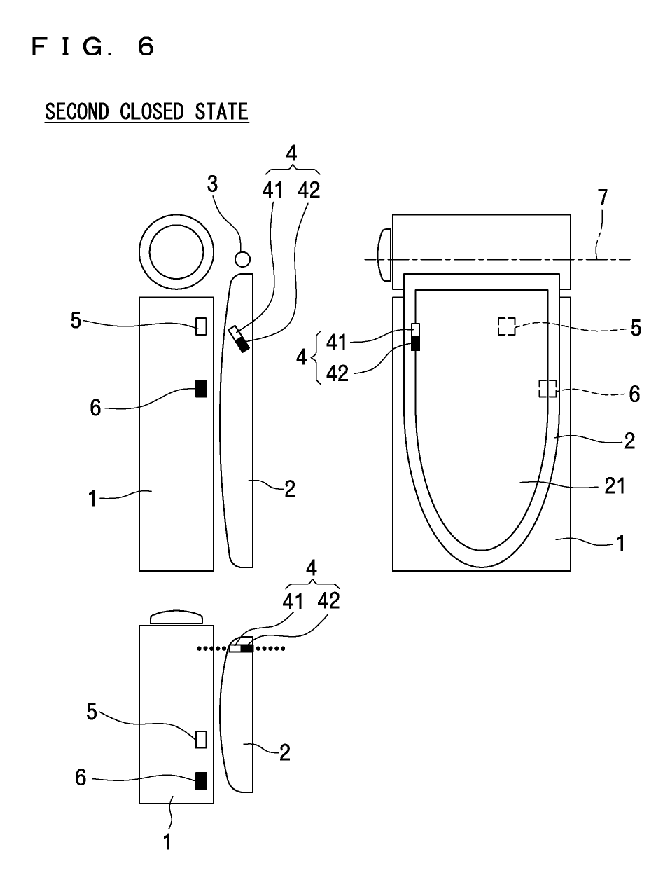

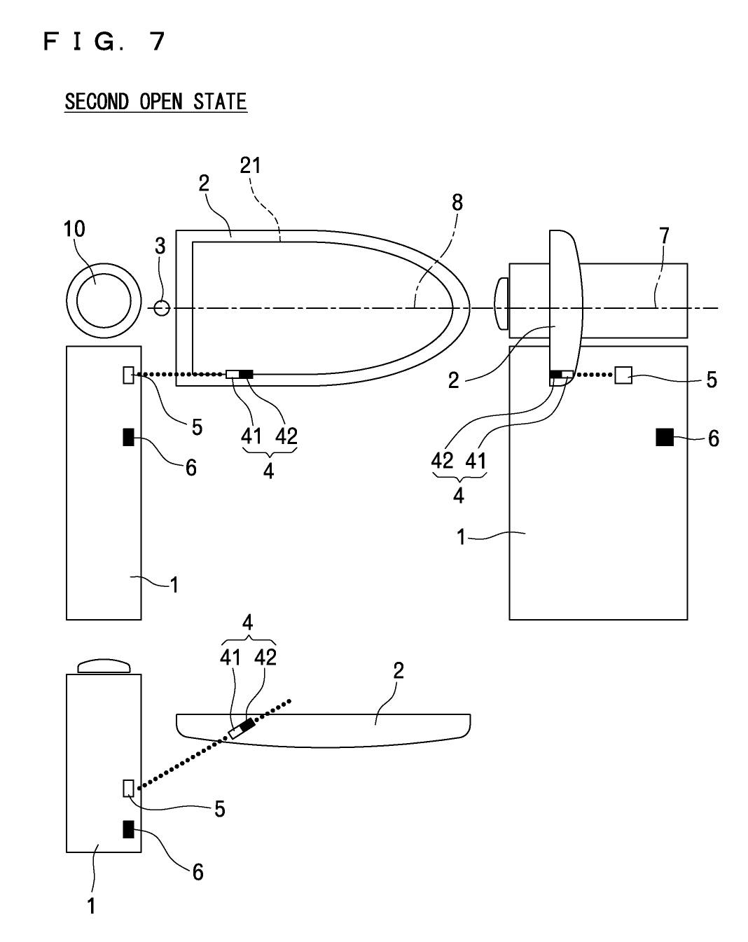

As shown in FIG. 2, the second housing 2 can be opened and closed relative to the first housing 1 as indicated by arrow A, by being rotated about the first hinge shaft 7. Further, as shown in FIG. 3, by the second housing 2 being regularly and reversely rotated about the second hinge shaft 8 in the state as being opened from the first housing 1 by 90 degrees, the orientation of the outer face 23 of the second housing 2 can be changed as indicated by arrow B. Thus, the first closed state shown in FIG. 4, the first open state shown in FIG. 5, the second closed state shown in FIG. 6, and the second open state shown in FIG. 7 can be set.

In the first closed state as shown in FIG. 4, the second housing 2 is closed while having its inner face opposed to the side face of the first housing 1. Thus, the entire structure is folded in a compact manner. In addition, since the display 21 of the second housing 2 is hidden, any damage that may be done to the display 21 can be prevented when the camera is carried.

In the first closed state, the S pole magnetic field sensor 6 is arranged at the position on the extended line from the magnetizing direction axis of the magnet 4 where the S pole magnetic field sensor 6 receives the magnetic field from the S pole 42 most intensively. The S pole magnetic field sensor 6 turns ON by the magnetic field generated from the S pole 42.

On the other hand, the N pole magnetic field sensor 5 is displaced from the extended line from the magnetizing direction axis of the magnet 4. Therefore, the N pole magnetic field sensor 5 stays OFF because it hardly receives the magnetic field from the N pole 41.

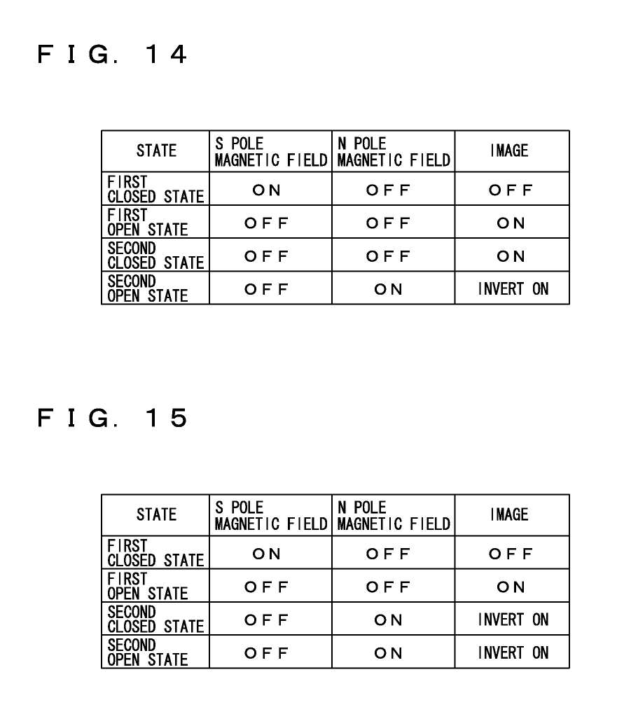

Accordingly, as shown in FIG. 14, when the S pole magnetic field sensor 6 is ON and the N pole magnetic field sensor 5 is OFF, the image display of the display 21 is turned OFF.

In the first open state as shown in FIG. 5, by the second housing 2 being rotated by 90 degrees about the first hinge shaft 7 from the first closed state, as well as being rotated counterclockwise by approximately 90 degrees about the second hinge shaft 8, the second housing 2 is opened so that the display 21 faces the user holding the first housing 1. Thus, the user can shoot the front landscape while checking the video image of the display 21.

In the first open state, the N pole magnetic field sensor 5 and the S pole magnetic field sensor 6 are each displaced from the extended line from the magnetizing direction axis of the magnet 4. Therefore, the N pole magnetic field sensor 5 and the S pole magnetic field sensor 6 stay OFF because they hardly receive the magnetic fields from the N pole 41 and the S pole 42.

Therefore, as shown in FIG. 14, when both the S pole magnetic field sensor 6 and the N pole magnetic field sensor 5 are OFF, the image display of the display 21 is turned ON.

In the second closed state as shown in FIG. 6, the second housing 2 is closed while having its outer face opposed to the side face of the first housing 1. Thus, since the display 21 can be exposed in the state where the second housing 2 is closed, the shot video image can be watched on the display 21 in the state where the entire structure is folded in a compact manner.

In the second closed state, the N pole magnetic field sensor 5 and the S pole magnetic field sensor 6 are each displaced from the extended line from the magnetizing direction axis of the magnet 4. Therefore, the N pole magnetic field sensor 5 and the S pole magnetic field sensor 6 stay OFF because they hardly receive the magnetic fields from the N pole 41 and the S pole 42.

Therefore, as shown in FIG. 14, when both the S pole magnetic field sensor 6 and the N pole magnetic field sensor 5 are OFF, the image display of the display 21 is turned ON.

In the second open state as shown in FIG. 7, by the second housing 2 being rotated by 90 degrees about the first hinge shaft 7 from the first closed state, as well as being rotated clockwise by approximately 90 degrees about the second hinge shaft 8, the second housing 2 is opened so that the display 21 is oriented in the same direction as the taking lens 10. Thus, the user can shoot himself/herself while checking the video image of the display 21 with the taking lens 10 oriented toward the user himself/herself.

In the second open state, the N pole magnetic field sensor 5 is arranged at the position on the extended line from the magnetizing direction axis of the magnet 4 where the N pole magnetic field sensor 5 receives the magnetic field from the N pole 41 most intensively. The N pole magnetic field sensor 5 turns ON by the magnetic field generated from the N pole 41.

On the other hand, the S pole magnetic field sensor 6 is displaced from the extended line from the magnetizing direction axis of the magnet 4. Therefore, the S pole magnetic field sensor 6 stays OFF because it hardly receives the magnetic field from the S pole 42.

Accordingly, as shown in FIG. 14, when the S pole magnetic field sensor 6 is OFF and the N pole magnetic field sensor 5 is ON, the image display of the display 21 is turned ON and the orientation of the image display is inverted.

In the second open state, the orientation of the display 21 is inverted upside down with reference to the first open state and, therefore, the orientation of the image display is inverted accordingly. Thus, the user can watch the image in the normal orientation.

In connection with the video camera according to the first embodiment, the magnet 4 is stored in the second housing 2 in the attitude having its magnetizing direction axis tilted relative to the second hinge shaft 8. Therefore, even when the magnet 4 is one in number, it is possible to arrange the S pole magnetic field sensor 6 on the extended line from the magnetizing direction axis of the magnet 4 in the first closed state shown in FIG. 4, and to arrange the N pole magnetic field sensor 5 on the extended line from the magnetizing direction axis of the magnet 4 in the second open state shown in FIG. 7. Thus, by one of the S pole magnetic field sensor 6 and the N pole magnetic field sensor 5 being turned ON, the first closed state and the second open state can be discerned from each other.

Accordingly, by setting the number of pieces of the magnet 4 to be one, a reduction in size and weight of the video camera can be realized. Further, interference of the magnetic fields incurred by provision of a plurality of magnets can be avoided, whereby failure in sensing can be prevented.

### 2. Second Embodiment

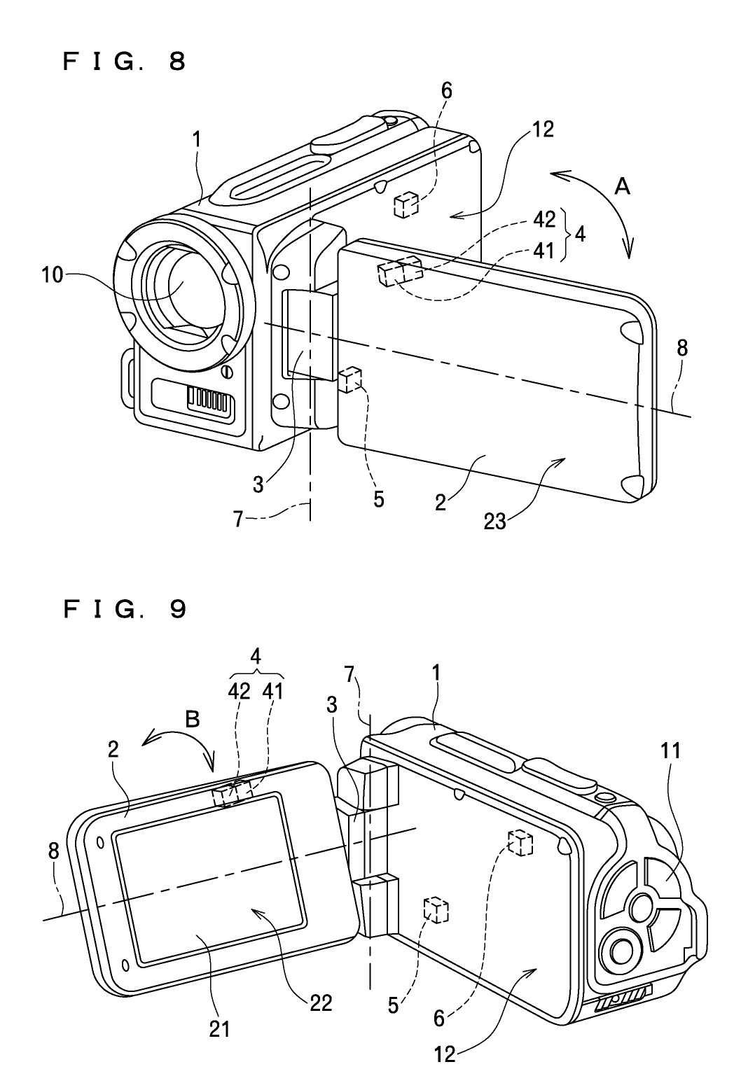

As shown in FIGS. 8 and 9, a video camera according to a second embodiment is a horizontal type video camera, and a second housing 2 is coupled to the side portion of a horizontally long first housing 1 so as to be opened and closed via a double shaft hinge mechanism 3.

The double shaft hinge mechanism 3 has a first hinge shaft 7 that extends in the top-bottom direction and that is coupled to the first housing 1, and a second hinge shaft 8 that extends in the direction being perpendicular to the first hinge shaft 7 and that is coupled to the second housing 2. The first hinge shaft 7 and the second hinge shaft 8 are perpendicular to each other.

The first housing 1 has a side face 12 that is parallel to the first hinge shaft 7, and the second housing 2 has an inner face 22 and an outer face 23 that extend along the second hinge shaft 8.

The first housing 1 is provided with a taking lens 10 and an operation button 11. At the inner face 22 of the second housing 2, a display 21 is arranged.

In the second housing 2, a magnet 4 that is magnetized in one axial direction to have an N pole 41 and an S pole 42 is arranged, such that its magnetizing direction axis is tilted relative to the second hinge shaft 8.

On the other hand, in the first housing 1, an N pole magnetic field sensor 5 capable of sensing the magnetic field generated from the N pole 41 of the magnet 4, and an S pole magnetic field sensor 6 capable of sensing the magnetic field generated from the S pole 42 of the magnet 4 are arranged with a deviation of two directions i.e., in the first hinge shaft 7 direction along the side face 12, and the axial direction perpendicular to the first hinge shaft 7.

As shown in FIG. 8, the second housing 2 can be opened and closed relative to the first housing 1 as indicated by arrow A, by being rotated about the first hinge shaft 7. Further, as shown in FIG. 9, by the second housing 2 being regularly and reversely rotated about the second hinge shaft 8 in the state as being opened from the first housing 1 by 90 degrees, the orientation of the inner face 22 of the second housing 2 can be changes as indicated by arrow B.

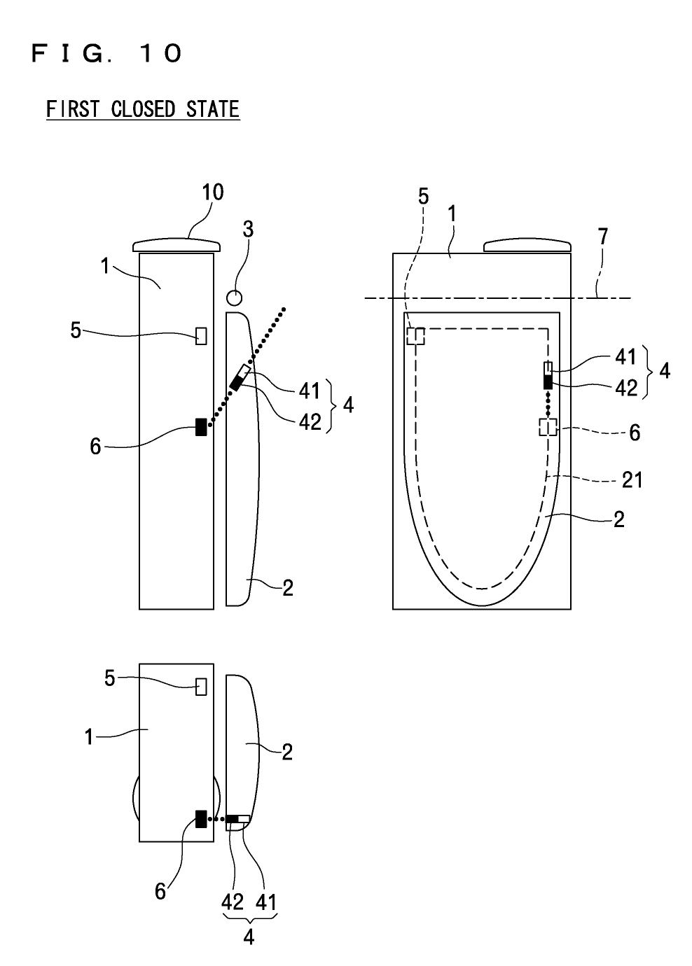

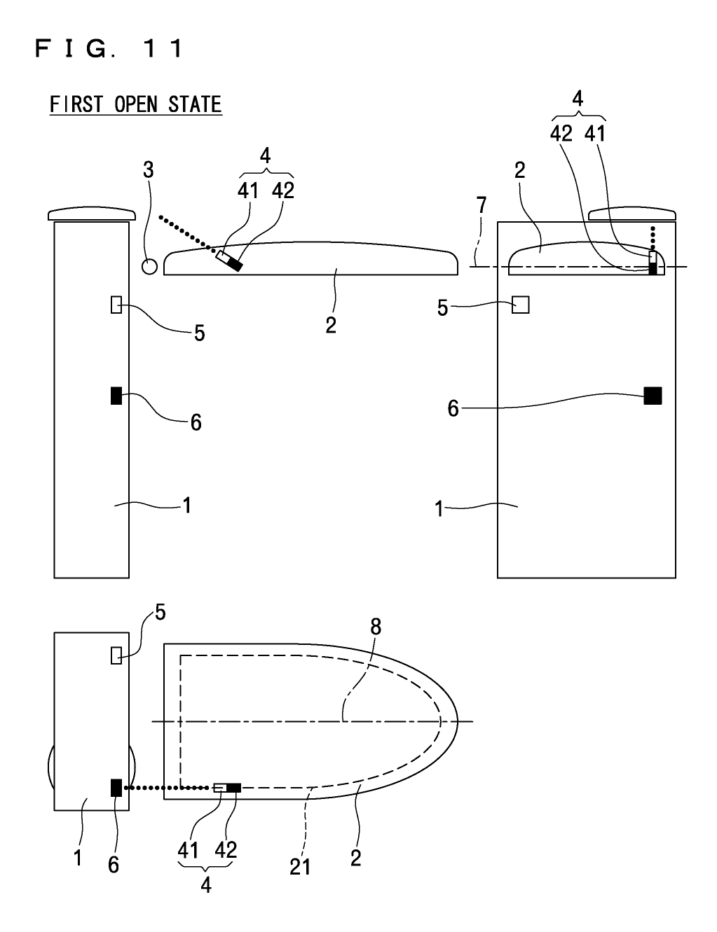

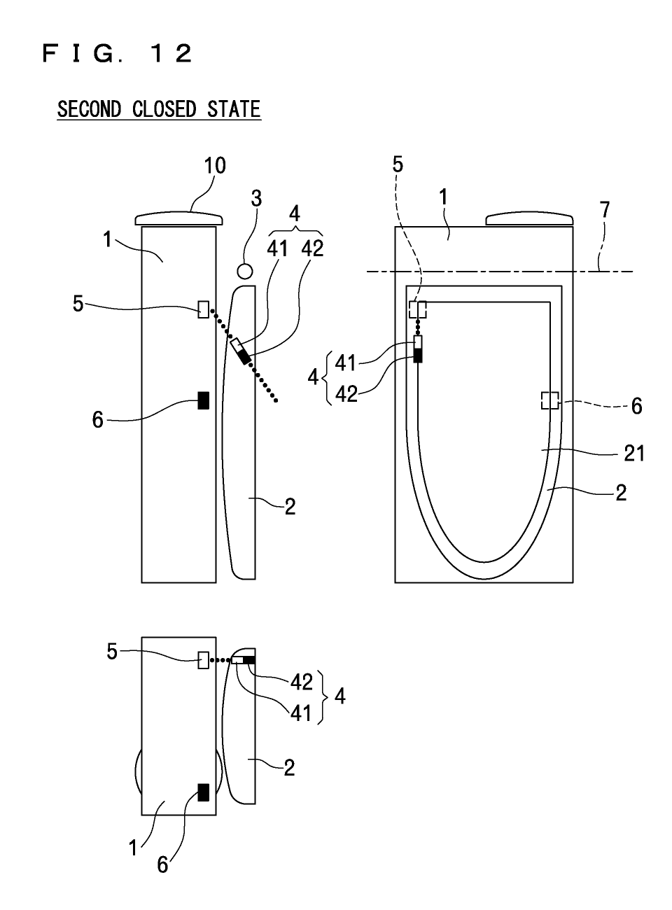

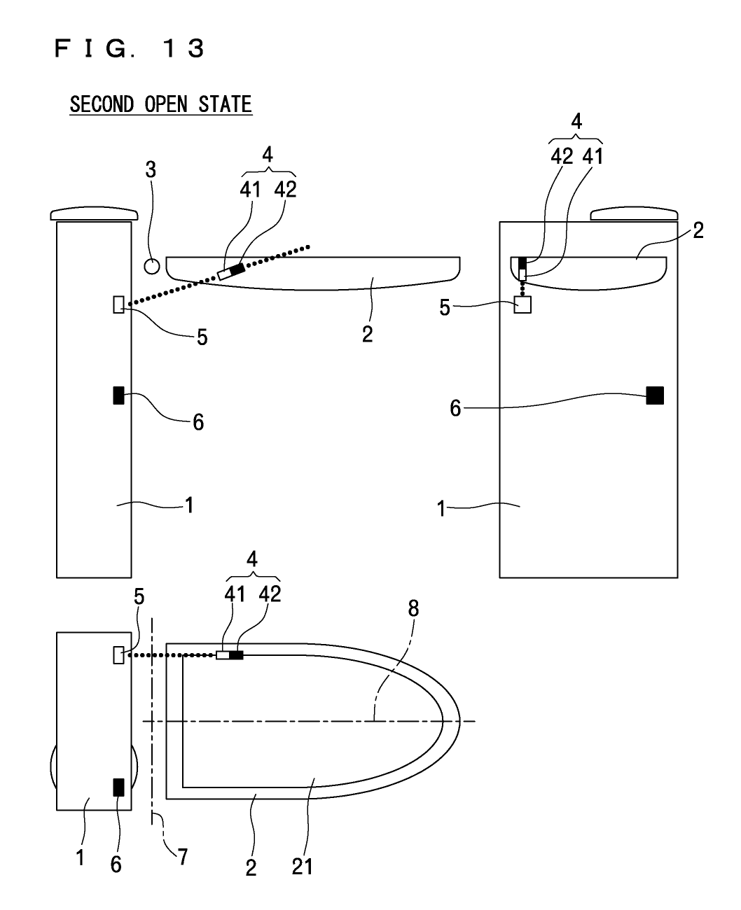

Thus, the first closed state shown in FIG. 10, the first open state shown in FIG. 11, the second closed state shown in FIG. 12, and the second open state shown in FIG. 13 can be set.

In the first closed state as shown in FIG. 10, the second housing 2 is closed with its inner face opposed to the side face of the first housing 1. Thus, the entire structure is folded in a compact manner. In addition, since the display 21 of the second housing 2 is hidden, any damage that may be done to the display 21 can be prevented when the video camera is carried.

In the first closed state, the S pole magnetic field sensor 6 is arranged at the position on the extended line from the magnetizing direction axis of the magnet 4 where the S pole magnetic field sensor 6 receives the magnetic field from the S pole 42 most intensively. The S pole magnetic field sensor 6 turns ON by the magnetic field generated from the S pole 42.

On the other hand, the N pole magnetic field sensor 5 is displaced from the extended line from the magnetizing direction axis of the magnet 4. Therefore, the N pole magnetic field sensor 5 stays OFF because it hardly receives the magnetic field from the N pole 41.

Accordingly, as shown in FIG. 15, when the S pole magnetic field sensor 6 is ON and the N pole magnetic field sensor 5 is OFF, the image display of the display 21 is turned OFF.

In the first open state as shown in FIG. 11, by the second housing 2 being rotating by 90 degrees about the first hinge shaft 7 from the first closed state, the second housing 2 is opened so that the display 21 faces the user holding the first housing 1. Thus, the user can shoot the front landscape while checking the video image of the display 21.

In the first open state, the N pole magnetic field sensor 5 and the S pole magnetic field sensor 6 are each displaced from the extended line from the magnetizing direction axis of the magnet 4. Therefore, the N pole magnetic field sensor 5 and the S pole magnetic field sensor 6 stay OFF because they hardly receive the magnetic fields from the N pole 41 and the S pole 42.

Therefore, as shown in FIG. 15, when both the S pole magnetic field sensor 6 and the N pole magnetic field sensor 5 are OFF, the image display of the display 21 is turned ON.

In the second closed state as shown in FIG. 12, the second housing 2 is closed while having its outer face opposed to the side face of the first housing 1. Thus, since the display 21 can be exposed in the state where the second housing 2 is closed, the shot video image can be watched on the display 21 in the state where the entire structure is folded in a compact manner.

In the second closed state, the N pole magnetic field sensor 5 is arranged at the position on the extended line from the magnetizing direction axis of the magnet 4 where the N pole magnetic field sensor 5 receives the magnetic field from the N pole 41 most intensively. The N pole magnetic field sensor 5 turns ON by the magnetic field generated from the N pole 41.

On the other hand, the S pole magnetic field sensor 6 is displaced from the extended line from the magnetizing direction axis of the magnet 4. Therefore, the S pole magnetic field sensor 6 stays OFF because it hardly receives the magnetic field from the S pole 42.

Accordingly, as shown in FIG. 15, when the S pole magnetic field sensor 6 is OFF and the N pole magnetic field sensor 5 is ON, the image display of the display 21 is turned ON and the orientation of the image display is inverted.

In the second closed state, the orientation of the display 21 is inverted upside down with reference to the first open state and, therefore, the orientation of the image display is inverted accordingly. Thus, the user can watch the image in the normal orientation.

In the second open state as shown in FIG. 13, by the second housing 2 being rotated by 90 degrees about the first hinge shaft 7 from the first closed state, as well as being rotated by 180 degrees about the second hinge shaft 8, the second housing 2 is opened so that the display 21 is oriented in the same direction as the taking lens 10. Thus, the user can shoot himself/herself while checking the video image of the display 21 with the taking lens 10 oriented toward the user himself/herself.

In the second open state, the N pole magnetic field sensor 5 is arranged at the position on the extended line from the magnetizing direction axis of the magnet 4 where the N pole magnetic field sensor 5 receives the magnetic field from the N pole 41 most intensively. The N pole magnetic field sensor 5 turns ON by the magnetic field generated from the N pole 41.

On the other hand, the S pole magnetic field sensor 6 is displaced from the extended line from the magnetizing direction axis of the magnet 4. Therefore, the S pole magnetic field sensor 6 stays OFF because it hardly receives the magnetic field from the S pole 42.

Accordingly, as shown in FIG. 15, when the S pole magnetic field sensor 6 is OFF and the N pole magnetic field sensor 5 is ON, the image display of the display 21 is turned ON and the orientation of the image display is inverted.

In the second open state, the orientation of the display 21 is inverted upside down with reference to the first open state and, therefore, the orientation of the image display is inverted accordingly. Thus, the user can watch the image in the normal orientation.

In connection with the video camera according to the second embodiment, the magnet 4 is stored in the second housing 2 in the attitude having its magnetizing direction axis tilted relative to the second hinge shaft 8. Therefore, even when the magnet 4 is one in number, it is possible to arrange the S pole magnetic field sensor 6 on the extended line from the magnetizing direction axis of the magnet 4 in the first closed state shown in FIG. 10, and to arrange the N pole magnetic field sensor 5 on the extended line from the magnetizing direction axis of the magnet in the second closed state shown in FIG. 12 and in the second open state shown in FIG. 13. Thus, by one of the S pole magnetic field sensor 6 and the N pole magnetic field sensor 5 being turned ON, the first closed state and the second closed state or the second open state can be discerned from each other.

Accordingly, by setting the number of pieces of the magnet 4 to be one, a reduction in size and weight of the video camera can be realized. Further, interference of the magnetic fields incurred by provision of a plurality of magnets can be avoided, whereby failure in sensing can be prevented.

It is to be noted that, the structure of the constituents of the present invention is not limited to the embodiments, and various changes can be made by those skilled in the art within the range not departing from the spirit of the present invention. For example, similar effect can be achieved with the structure in which the positional relationship of the N pole 41 and the S pole 42 of the magnet 4 in the second housing 2 according to the embodiments is inverted, and in which the position of the N pole magnetic field sensor 5 and that of the S pole magnetic field sensor 6 in the first housing 1 are replaced by each other.

Further, in the embodiments, the magnet 4 is arranged in the first housing 1 and the N pole magnetic field sensor 5 and the S pole magnetic field sensor 6 are arranged in the second housing 2. However, it is also possible to employ the structure in which the magnet 4 is arranged in the second housing 2 and the N pole magnetic field sensor 5 and the S pole magnetic field sensor 6 are arranged in the first housing 1.

The present invention is not limited to video cameras, and can be applied to communication devices such as mobile phones, or to information processing devices such as personal computers.

Further, the present invention is not limited to an opening-closing type of electronic device made up of the first housing 1 and the second housing 2. For example, the present invention can be applied to an electronic device in which a manipulation lever, an antenna or the like serving as the second body is rotatably coupled to a device body serving as the first body, so as to determine the rotating state of the manipulation lever, the antenna or the like.

What is claimed is:

1. A rotary type electronic device, comprising:
a first body and a second body that are rotatably coupled to each other via a hinge mechanism having at least two hinge shafts, wherein
the hinge mechanism has a first hinge shaft coupled to the first body and a second hinge shaft coupled to the second body,
rotation of the second body relative to the first body about at least one of the first hinge shaft and the second hinge shaft allows a plurality of states to be set, a plurality of the states that are relative attitudes of the second body to the first body being different from one another,
the second body stores a magnet being magnetized in one axial direction to have an N pole and an S pole,
the first body stores an N pole magnetic field sensor sensing a magnetic field generated from the N pole of the magnet, and an S pole magnetic field sensor sensing a magnetic field generated from the S pole of the magnet,
the magnet is arranged to be in an attitude such that a magnetizing direction axis tilts relative to the second hinge shaft,
the S pole magnetic field sensor is arranged at a position on an extended line from the magnetizing direction axis of the magnet where the S pole magnetic field sensor receives the magnetic field from the S pole, in one of a plurality of the states, and
the N pole magnetic field sensor is arranged at a position on the extended line from the magnetizing direction axis of the magnet where the N pole magnetic field sensor receives the magnetic field from the N pole, in one of the states other than the one state.

2. A rotary type electronic device, comprising:
a first body and a second body that are rotatably coupled to each other via a hinge mechanism having at least two hinge shafts, wherein
the hinge mechanism has a first hinge shaft coupled to the first body and a second hinge shaft coupled to the second body,
the first body has a side face extending substantially parallel with the first hinge shaft and the second body has an inner face and an outer face extending substantially parallel with the second hinge shaft,
a first closed state in which the inner face of the second body is closed as being opposed to the side face of the first body, a second closed state in which the outer face of the second body is closed as being opposed to the side face of the first body, a first open state in which the second body is opened from the side face of the first body to orient the inner face of the second body in a direction crossing the first hinge shaft, and a second open state in which the second body is rotated by approximately 180 degrees about the second hinge shaft from the first open state can be set,
the second body stores a magnet magnetized in one axial direction to have an N pole and an S pole,
the first body stores an N pole magnetic field sensor sensing a magnetic field generated from the N pole of the magnet and an S pole magnetic field sensor sensing a magnetic field generated from the S pole of the magnet,
the magnet is arranged to be in an attitude such that a magnetizing direction axis tilts relative to the second hinge shaft,
the S pole magnetic field sensor is arranged at a position on an extended line from the magnetizing direction axis of the magnet where the S pole magnetic field sensor receives the magnetic field from the S pole, in one of the first closed state, the first open state, the second closed state, and the second open state, and
the N pole magnetic field sensor is arranged at a position on the extended line from the magnetizing direction axis of the magnet where the N pole magnetic field sensor receives the magnetic field from the N pole, in one of the states other than the one state.

3. A rotary type electronic device, comprising:
a first body and a second body that are rotatably coupled to each other via a hinge mechanism having at least two hinge shafts, wherein
the hinge mechanism has a first hinge shaft coupled to the first body and a second hinge shaft coupled to the second body,
the first body has a side face extending substantially parallel with the first hinge shaft and the second body has an inner face and an outer face extending substantially parallel with the second hinge shaft,
a first closed state in which the inner face of the second body is closed as being opposed to the side face of the first body, a second closed state in which the outer face of the second body is closed as being opposed to the side face of the first body, a first open state in which the second body is opened from the side face of the first body to orient the inner face of the second body in a direction crossing the first hinge shaft, and a second open state in which the second body is rotated by approximately 180 degrees about the second hinge shaft from the first open state can be set,
the first body stores a magnet magnetized in one axial direction to have an N pole and an S pole,
the second body stores an N pole magnetic field sensor sensing a magnetic field generated from the N pole of the magnet and an S pole magnetic field sensor sensing a magnetic field generated from the S pole of the magnet,
the magnet is arranged to be in an attitude such that a magnetizing direction axis tilts relative to the second hinge shaft,
the S pole magnetic field sensor is arranged at a position on an extended line from the magnetizing direction axis of the magnet where the S pole magnetic field sensor receives the magnetic field from the S pole, in one of the first closed state, the first open state, the second closed state, and the second open state, and
the N pole magnetic field sensor is arranged at a position on the extended line from the magnetizing direction axis of the magnet where the N pole magnetic field sensor receives the magnetic field from the N pole, in one of the states other than the one state.

4. The rotary type electronic device according to claim 2, wherein
the S pole magnetic field sensor is arranged at a position where the S pole magnetic field sensor receives the magnetic field from the S pole of the magnet in the first closed state, and
the N pole magnetic field sensor is arranged at a position where the N pole magnetic field sensor receives the magnetic field from the N pole of the magnet in the second open state.

5. The rotary type electronic device according to claim 3, wherein
the S pole magnetic field sensor is arranged at a position where the S pole magnetic field sensor receives the magnetic field from the S pole of the magnet in the first closed state, and
the N pole magnetic field sensor is arranged at a position where the N pole magnetic field sensor receives the magnetic field from the N pole of the magnet in the second open state.

6. The rotary type electronic device according to claim 2, wherein
the S pole magnetic field sensor is arranged at a position where the S pole magnetic field sensor receives the magnetic field from the S pole of the magnet in the first closed state, and
the N pole magnetic field sensor is arranged at a position where the N pole magnetic field sensor receives the magnetic field from the N pole of the magnet in the second closed state and the second open state.

7. The rotary type electronic device according to claim 3, wherein
the S pole magnetic field sensor is arranged at a position where the S pole magnetic field sensor receives the magnetic field from the S pole of the magnet in the first closed state, and
the N pole magnetic field sensor is arranged at a position where the N pole magnetic field sensor receives the magnetic field from the N pole of the magnet in the second closed state and the second open state.

8. The rotary type electronic device according to claim 2, wherein
the first body is provided with a taking lens having an optical axis being parallel to the first hinge shaft of the hinge mechanism or crossing the first hinge shaft of the hinge mechanism at an angle equal to or less than 45 degrees, and
the inner face of the second body is provided with a display on which an image shot by the taking lens is displayed.

9. The rotary type electronic device according to claim 3, wherein
the first body is provided with a taking lens having an optical axis being parallel to the first hinge shaft of the hinge mechanism or crossing the first hinge shaft of the hinge mechanism at an angle equal to or less than 45 degrees, and
the inner face of the second body is provided with a display on which an image shot by the taking lens is displayed.

10. The rotary type electronic device according to claim 4, wherein
the first body is provided with a taking lens having an optical axis being parallel to the first hinge shaft of the hinge mechanism or crossing the first hinge shaft of the hinge mechanism at an angle equal to or less than 45 degrees, and
the inner face of the second body is provided with a display on which an image shot by the taking lens is displayed.

11. The rotary type electronic device according to claim 5, wherein
the first body is provided with a taking lens having an optical axis being parallel to the first hinge shaft of the hinge mechanism or crossing the first hinge shaft of the hinge mechanism at an angle equal to or less than 45 degrees, and
the inner face of the second body is provided with a display on which an image shot by the taking lens is displayed.

12. The rotary type electronic device according to claim 2, wherein
the first body is provided with a taking lens having an optical axis being parallel to the first hinge shaft of the hinge mechanism or crossing the first hinge shaft of the hinge mechanism at an angle equal to or less than 45 degrees, and
the inner face of the second body is provided with a display on which an image shot by the taking lens is displayed.

13. The rotary type electronic device according to claim 3, wherein
the first body is provided with a taking lens having an optical axis crossing the first hinge shaft of the hinge mechanism at an angle of approximately 90 degrees, and
the inner face of the second body is provided with a display on which an image shot by the taking lens is displayed.

14. The rotary type electronic device according to claim 6, wherein
the first body is provided with a taking lens having an optical axis crossing the first hinge shaft of the hinge mechanism at an angle of approximately 90 degrees, and
the inner face of the second body is provided with a display on which an image shot by the taking lens is displayed.

15. The rotary type electronic device according to claim 7, wherein
the first body is provided with a taking lens having an optical axis crossing the first hinge shaft of the hinge mechanism at an angle of approximately 90 degrees, and
the inner face of the second body is provided with a display on which an image shot by the taking lens is displayed.

16. The rotary type electronic device according to claim 8, wherein
ON/OFF of the display and orientation of image display are controlled based on a sense signal of the N pole magnetic field sensor and the S pole magnetic field sensor.

17. The rotary type electronic device according to claim 9, wherein
ON/OFF of the display and orientation of image display are controlled based on a sense signal of the N pole magnetic field sensor and the S pole magnetic field sensor.

18. The rotary type electronic device according to claim 10, wherein
ON/OFF of the display and orientation of image display are controlled based on a sense signal of the N pole magnetic field sensor and the S pole magnetic field sensor.

19. The rotary type electronic device according to claim 11, wherein
ON/OFF of the display and orientation of image display are controlled based on a sense signal of the N pole magnetic field sensor and the S pole magnetic field sensor.

20. The rotary type electronic device according to claim 12, wherein
ON/OFF of the display and orientation of image display are controlled based on a sense signal of the N pole magnetic field sensor and the S pole magnetic field sensor.
